(19) United States
(12) Patent Application Publication
(10) Pub. No.: US 2008/0052864 A1
(43) Pub. Date: Mar. 6, 2008

(54) Wiper Crank With a Wiper Arm and a Wiper Blade

(76) Inventors: Michael Weiler, Chungchongbuk-Do (DE); Joachim Zimmer, Sasbach (DE); Harald Rapp, Buehl (DE); Jan Dietrich, Buehl (DE)

Correspondence Address: MICHAEL BEST & FRIEDRICH LLP, 100 E WISCONSIN AVENUE, Suite 3300, MILWAUKEE, WI, 53202, US

(21) Appl. No.: 10/539,990

(22) PCT Filed: Aug. 4, 2003
(86) PCT No.: PCT/DE03/02602

§ 371 Date: Sep. 6, 2007

(30) Foreign Application Priority Data
Dec. 19, 2002 (DE) 102 59 479.1

(51) Int. Cl. B60S 1/40

(52) U.S. Cl. 15/250.32

(57) ABSTRACT

The invention relates to a wiper crank with a wiper arm (10a-10h) and a wiper blade (12a-12h). According to the invention, the wiper arm (10a-10h) and the wiper blade (12a-12h) have a joint-free connection.

### PRIOR ART

The invention starts with a wiper lever in accordance with the pre-characterizing clause of claim 1.

A generic wiper lever with a wiper arm and a wiper blade is known from DE 198 56 300 A1. The wiper blade features an elastic wiper strip support that is curved in an arched manner, on which a long-stretched-out wiper strip is fastened, whose wiper lip extends on a concave side of the wiper strip support along said wiper strip support. Furthermore, the wiper blade includes a wind deflector arranged on a convex side of the wiper strip support. The strand-shaped wiper arm is connected to the wiper blade via an articulation. For this purpose, the wiper blade features a bearing point formed from a transverse bore hole in its longitudinal center section for an articulated bolt fastened on the wiper arm.

### ADVANTAGES OF THE INVENTION

The invention starts with a wiper lever with a wiper arm and a wiper blade.

It is proposed that the wiper arm and the wiper blade be connected to each other in a non-articulated manner. An especially simple and flat design can be achieved and the number of components, the assembly expense and the costs can be reduced in particular. With the aid of a reversing motor, the wiper lever can be guided, in an extended parking position, into an especially narrow recess, e.g., under an engine hood or in a specially formed A-pillar of the motor vehicle. In addition, components that are subject to wear and susceptible to defects, particularly bearing components, can be reduced at least to a large extent.

In this context, “connected in a non-articulated manner” should be understood that the wiper arm and the wiper blade are connected without a materially executed swivel axis around which the wiper arm and the wiper blade could be swiveled relative to each other. Components that enable a relative movement between the wiper arm and the wiper blade due to a material deformation, particularly due to an elastic deformation, should not be viewed as an articulation in this context and should also be included in the extent of protection, e.g., integral hinges, elastic sections, etc.

If the wiper arm and the wiper blade are connected via at least one elastic connecting piece, equalization of a stroke movement or a relative movement between the wiper arm and the wiper blade can be advantageously guaranteed during operation. As a rule, it is also conceivable, however, that the wiper arm and the wiper blade are connected to each other via an essentially rigid connecting piece. Equalization of relative movements between the wiper arm and the wiper blade could be achieved in this case via the wiper arm and/or via the wiper blade itself.

In another embodiment of the invention, it is proposed that the wiper blade feature an elastic wiper strip-supporting element connected to the wiper arm in a non-articulated manner, on whose concave side a wiper lip of a wiper strip extends in an assembled state. These types of so-called non-articulated wiper blades can be executed to be especially flat and an overall especially flat wiper lever can be achieved. In addition, the number of components can be reduced considerably as compared with bracket wiper blades, which can also be integrated as a rule into a wiper lever in accordance with the invention.

In addition, it is proposed that the wiper arm feature at least, one elastic-supporting element. An articulation in the wiper arm can be dispensed with and additional components can be saved and the total overall height of the wiper lever can be reduced further. Furthermore, the wiper arm and the wiper blade can be manufactured advantageously in a cost-effective manner in a combination with a bracket-less wiper blade on at least essentially the same production machines.

The connecting piece can be formed from an additional component, e.g., from an elastic buffer of a leaf spring etc., or can be executed advantageously as a single piece with at least one elastic supporting element, such as a wiper strip supporting element and/or a supporting element of the wiper arm, thereby saving additional components, assembly expenses and costs.

If the wiper lever is designed to be multi-piece or if at least the wiper blade and the wiper arm are formed of separate components, said items can be advantageously designed separately for their function, and namely different materials and/or material strengths can be used in particular. If, on the other hand, the wiper arm and the wiper blade are executed at least partially as a single piece, additional components can in turn be saved and an especially cost-effective manufacture can be achieved, and namely particularly if the wiper arm and the wiper blade are formed of a common, punched bent component. Furthermore, a particularly harmonic bending line of the wiper lever can be achieved and weak points can be avoided in a simple way.

In another embodiment of the invention, it is proposed that the wiper blade be connected to the wiper arm via its outer wiper blade end or feature a bearing force initiation point on an outer wiper blade end. A longer wiper arm can be achieved and particularly in the case of an embodiment of the wiper arm with an elastic supporting element, an advantageously great length can be achieved, via which a relative movement between the wiper arm and the wiper blade can be equalized and a large relative movement of the wiper blade can be made possible essentially perpendicular to the windshield, e.g., for comfortable cleaning of the windshield. Moreover, an especially small inner circle of the wiper blade or a small distance of an inner wiper blade end to a drive shaft can be achieved, via which the wiper lever can be driven.

If the wiper blade is connected to the wiper arm via its inner wiper blade end or if the wiper blade features a bearing force initiation point on its inner wiper blade end, a wiper lever that is not sensitive to vibration can be achieved and a design can be realized with low material use.

If the wiper blade is connected to the wiper arm via an area between its wiper blade ends and particularly via its longitudinal center section or if the wiper blade features a bearing force initiation point in its longitudinal center section, an especially advantageous, particularly at least largely symmetrical distribution of forces can be achieved on the wiper blade.

Instead of alternatively, the proposed connecting points or bearing force initiation points, namely, on the outer wiper blade end, on the inner wiper blade end and in an area between the wiper blade ends, can also be combined as desired.

In another embodiment of the invention, it is proposed that the wiper arm be connected to the wiper blade via at least one transverse piece, whereby an advantageous distance between the wiper blade and the wiper arm can be achieved simply with low material use, via which relative movements between the two components can be equalized, e.g., via an elastic deformation. In addition, a wiper field that is yielded during operation can be advantageously adjusted via the transverse piece. The use of a transverse piece is particularly suited for connecting the wiper blade on its inner wiper blade end or in its longitudinal center section to the wiper arm, but can also be used for connecting the wiper blade on its outer wiper blade end to the wiper arm.

In addition, an advantageous distance between the wiper blade and the wiper arm can be achieved, via which a movement equalization can in turn be realized, in that the wiper arm and the wiper blade are connected via at least one deviation with an angle greater than 90°.

If the wiper blade features at least one slot-shaped recess to accommodate a wiper strip, proven wiper strips can be mounted simply on the wiper blade. As rule, however, the use of bonded wiper strips or wiper strips that are embodied as hollow profiles is also conceivable.

The wiper arm and the wiper blade are advantageously formed of an elastic steel sheet, whereby one can fall back on manufacturing facilities that have been proven for bracket-less wiper blades. However, other materials that appear to be meaningful to the person skilled in the art are also conceivable such as fiber-reinforced plastics, etc.

In order to achieve increased rigidity in at least individual areas, beads, U-profiles, etc. can also be provided, e.g., by these being formed on the wiper arm or on the wiper blade or by additional components being fastened.

Furthermore, it is conceivable to arrange a wind deflector on the wiper blade and/or on the wiper arm, which can be formed of an additional component, e.g., from a plastic component, or can be formed at least partially as a single piece on the wiper blade and/ or on the wiper arm, e.g., by it being formed as a single piece on a punched bent component.

The wiper lever in accordance with the invention can be executed as a high-value wiper lever used for both a front window as well as a rear window or can be executed as a so-called transport wiper lever, which is replaced by another wiper lever before delivery to the final customer.

### DRAWINGS

Additional advantages are yielded from the following description of the drawings. Exemplary embodiments of the invention are depicted in the drawings. The drawings, the description and the claims contain numerous features in combination. The person skilled in the art will also observe individual features expediently and combine them into additional, meaningful combinations.

The drawings show:

FIG. 1 A view from below before a bending process of a wiper lever with a bearing force initiation point on an outer wiper blade end.

FIG. 2 The wiper lever from FIG. 1 after a first bending process.

FIG. 3 A side view of the wiper lever from FIG. 1 after a second bending process.

FIG. 4 A view from below before a bending process of a wiper lever that is an alternative to FIG. 1 with a bearing force initiation point on an inner wiper blade end.

FIG. 5 A side view of the wiper lever from FIG. 4 after the bending process.

FIG. 6 A view from below of a wiper lever that is an alternative to FIG. 4 with a connecting piece formed from a transverse piece.

FIG. 7 A side view of the wiper lever from FIG. 6.

FIG. 8 A view in direction VIII in FIG. 7.

FIG. 9 A wiper lever that is an alternative to FIG. 6 shown from below before a bending process to form a 180° deviation.

FIG. 10 The wiper lever from FIG. 9 after the bending process.

FIG. 11 A side view of the wiper lever from FIG. 10.

FIG. 12 A view in direction XII in FIG. 11.

FIG. 13 A view from below of a wiper lever that is an alternative to FIG. 1 with a bearing force initiation point on a longitudinal center section of a wiper blade.

FIG. 14 A side view of the wiper lever from FIG. 13.

FIG. 15 A view from below of a wiper level that is an alternative to FIG. 13 with a single transverse piece.

FIG. 16 A side view of the wiper lever from FIG. 15.

FIG. 17 A wiper lever that is an alternative to FIG. 15 before a bending process to form a 180° deviation.

FIG. 18 The wiper lever from FIG. 17 after the bending process.

FIG. 19 A side view of the wiper lever from FIG. 18.

FIG. 20 A view in direction XX in FIG. 19.

FIG. 21 A wiper lever that is an alternative to FIG. 13 before a connection of a wiper arm and wiper blade.

FIG. 22 The wiper lever from FIG. 21 after the connection of the wiper arm and the wiper blade

FIG. 23 A side view of the wiper lever from FIG. 22.

### DESCRIPTION OF THE EXEMPLARY EMBODIMENTS

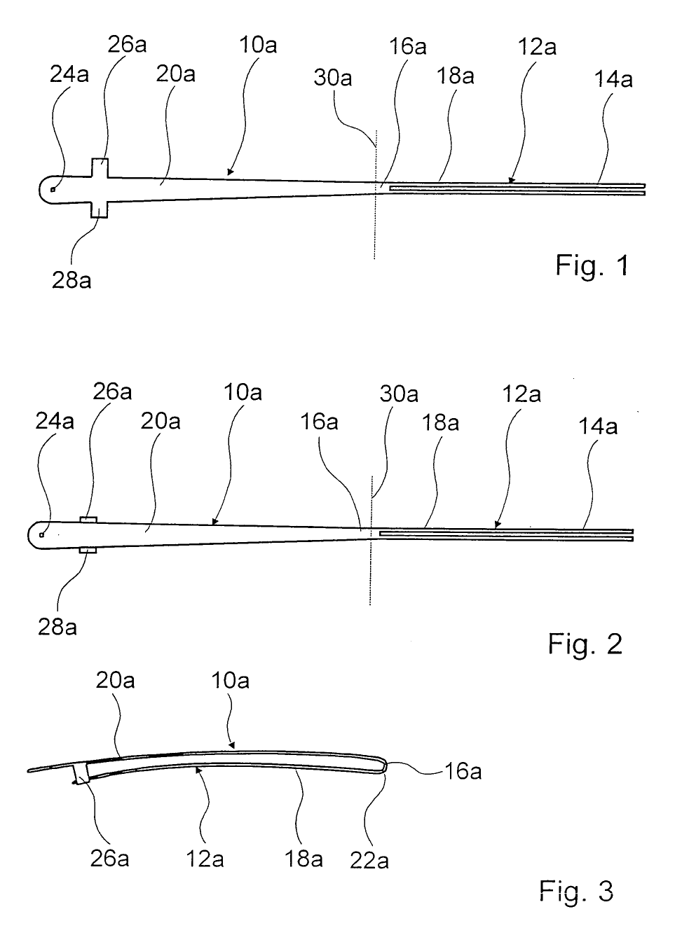

FIGS. 1 through 3 depict a wiper lever with a wiper arm 10a and a wiper blade 12a in various manufacturing stages, wherein the wiper arm 10a and the wiper blade 12a in accordance with the invention are connected in a non-articulated manner by an elastic connecting piece 16a. The wiper arm 10a, the connecting piece 16a and the wiper blade 12a are executed as a single piece and are formed of a common, long-stretched-out, punched bent component made of an elastic steel sheet. Instead of a single-piece design, a multi-piece design would also be conceivable, wherein the components can be connected in a finished state via different integral, positively engaged and/or frictional connections that appear to be meaningful to the person skilled in the art, e.g., via a riveted connection, a clamped connection, a screwed connection, a welded connection, and/or an adhesive connection, etc. In the case of a single-piece design, the area in which a wiper strip extends in an assembled state is viewed as the wiper blade 12a.

The wiper blade 12a features an elastic, curved wiper strip supporting element 18a connected to the wiper arm 10a in a non-articulated manner, on whose on whose concave side a wiper lip of a wiper strip extends in an assembled state (FIG. 3). The wiper strip supporting element 18a features a slot-shaped recess 14a extending in the longitudinal direction to accommodate the wiper strip. The recess 14a is executed to be to be open towards one free end of the wiper strip supporting element 18a. The wiper strip can thereby be inserted advantageously via the free end of the wiper strip supporting element 18a. However, the recess 14a, could also be executed to be closed towards the free end. The wiper arm 10a features an elastic supporting element 20a, which features a recess 24a on its free end for coupling to a drive shaft. Before a bending process that follows a punching process, the wiper lever is essentially executed to be flat and features two brackets 26a, 28a formed on the wiper arm 10a as a single piece that extend transverse to the longitudinal direction starting from the recess 24a shortly after said recess in the direction of the wiper blade 12a (FIG. 1).

In the bending process, the brackets 26a, 28a are bent 90° in the direction of one underside of the wiper lever (FIG. 2). In addition, the free end of the wiper blade 12a is bent in the direction of the free end of the wiper arm 10a, and namely by approx. 180° around a bending axis 30a, which runs perpendicular to the longitudinal extension and parallel to one underside of the wiper lever, in the area of the connecting piece 16a, which, when observed in the bent open state, is arranged starting from the recess 24a in the direction of the wiper blade 12a shortly after a longitudinal center.

Essentially a 180° deviation 22a is created in the area of the connecting piece 16a via which the wiper arm 10a and the wiper blade 12a are connected to each other (FIG. 3). In addition, slight longitudinal curvatures are formed on the wiper arm 10a and the wiper blade 12a. In addition to or as an alternative to the wiper blade 12a, the wiper arm 10a could also be bent around the bending axis 30a. The free end of the wiper blade 12a comes to lie in the area of the brackets 26a, 28a, which form a wiper blade guidance. Without additional components, vibrations of the wiper lever and in particular of the wiper blade can at least be reduced via the brackets 26a, 28a forming the wiper blade guidance.

The wiper blade 12a is connected to the wiper arm 10a via its outer wiper blade end and via the connecting piece 16a. A bearing force is transferred during operation to the wiper blade 12a in the area of an outer circle of the wiper blade 12a or from the wiper arm 10a via the connecting piece 16a and via the outer wiper blade end.

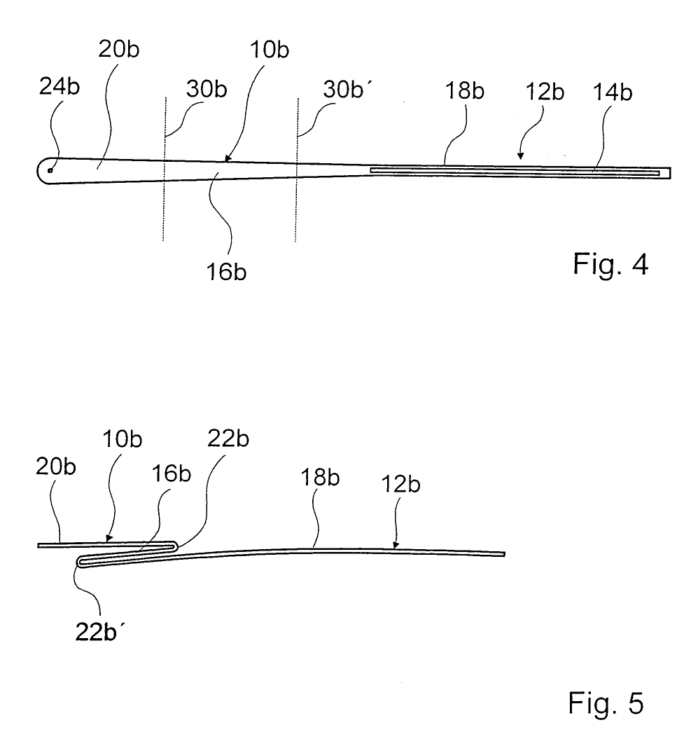

FIGS. 4 and 5 depict an alternative wiper lever. In terms of the exemplary embodiments, as a rule, essentially the same components and features are labeled in the description with the same reference numbers, whereby the letters “a” through “h” have been added for the purpose of differentiating between the exemplary embodiments. Moreover, reference can be made to the description of the exemplary embodiment in FIGS. 1 through 3 with respect to features and functions that do not change. The following description is restricted essentially to the differences from the exemplary embodiment in FIGS. 1 through 3.

The wiper lever includes a wiper arm 10b and a wiper blade 12b, which are connected in a non-articulated manner via an elastic connecting piece 16b. The wiper arm 10b, the connecting piece 16b and the wiper blade 12b are executed as a single piece and are formed of a common, long-stretched-out, punched bent component made of an elastic steel sheet.

Before a bending process that follows a punching process, the wiper lever is essentially executed to be flat (FIG. 4). In a first step in the bending process, the free end of the wiper blade 12b is bent in the direction of the free end of the wiper arm 10b, and namely by approx. 180° around a first bending axis 30b, which runs perpendicular to the longitudinal extension and parallel to one underside of the wiper lever, in the area of the connecting piece 16b. In a second step, the free end of the wiper blade 12b is bent opposite to the first bending direction by approx 180° around a second bending axis 30b′ in the area of the connecting piece 16b, which is aligned parallel to the first bending axis 30b and, when observed in the bent open state, is arranged starting from a recess 24b in the wiper arm 10b for coupling said wiper arm to a drive shaft, in the direction of the wiper blade 12b after the first bending axis 30b. An essentially S-shaped embodiment with two essentially 180° deviations 22b, 22b′ is created in the area of the connecting piece 16b, via which the wiper arm 10b and the wiper blade 12b are connected to each other (FIG. 5). Due to the S-shaped embodiment, an advantageous area is created via which a relative movement between the wiper arm 10b and the wiper blade 10b can be equalized. In addition to or as an alternative to the wiper blade 12b, the wiper arm 10b could also be bent around the bending axis 30b, 30b′.

The wiper blade 12b is connected to the wiper arm 10b via its inner wiper blade end and via the connecting piece 16b. A bearing force is transferred during operation to the wiper blade 12b in the area of an inner circle of the wiper blade 12b or from the wiper arm 10b via the connecting piece 16b and via the inner wiper blade end. In order to fasten a wiper strip to the wiper blade 12b, a slot-shaped recess 14b is introduced into an elastic, curved wiper strip supporting element 18b of the wiper blade 12b and the recess is executed to be closed in the area of the free end of the wiper blade 12b.

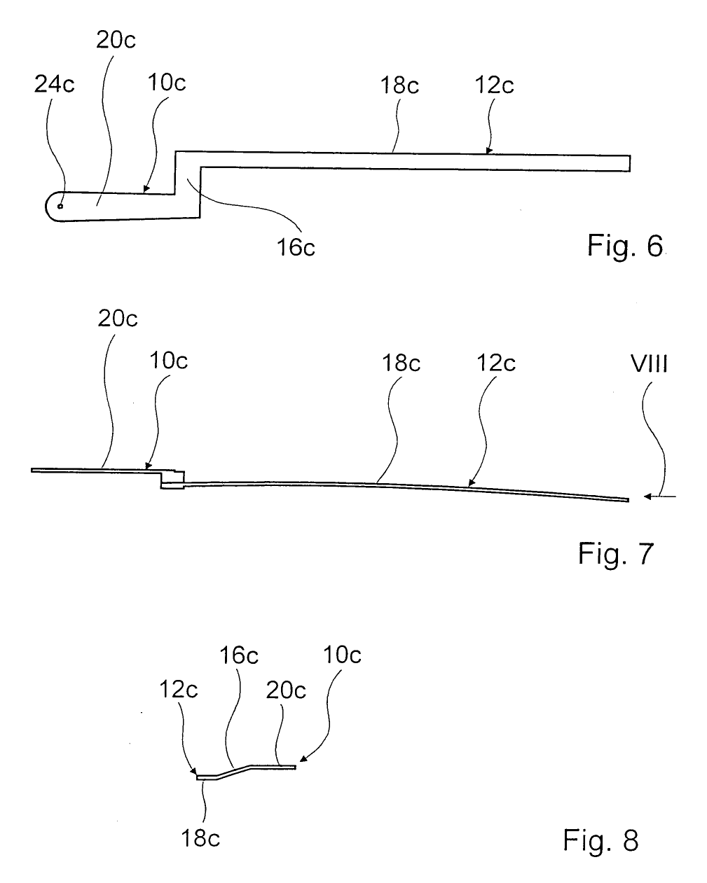

FIGS. 6 through 8 depict a wiper lever that is an alternative to that in FIGS. 4 and 5. The wiper lever features a connecting piece 16c formed by a transverse piece, which is aligned transverse to the longitudinal extension of the wiper lever, and via which a wiper arm 10c and a wiper blade 12c of the wiper lever are connected in a non-articulated manner. The wiper arm 10c, the connecting piece 16c and the wiper blade 12c are executed as a single piece and are formed of a common, long-stretched-out, punched bent component made of an elastic steel sheet.

The wiper blade 12c is connected to the wiper arm 10c via its inner wiper blade end and via the connecting piece 16c. In order to achieve a height offset between the wiper arm 10c and the wiper blade 12c perpendicular to a to-be-wiped windshield, the connecting piece 16c is executed in an angled manner (FIGS. 7 and 8).

A wiper strip that is executed as a hollow profile can be slid onto the wiper blade's 12c wiper strip supporting element 18c that is executed as a whole surface or without a recess, or a wiper strip can be adhered to it.

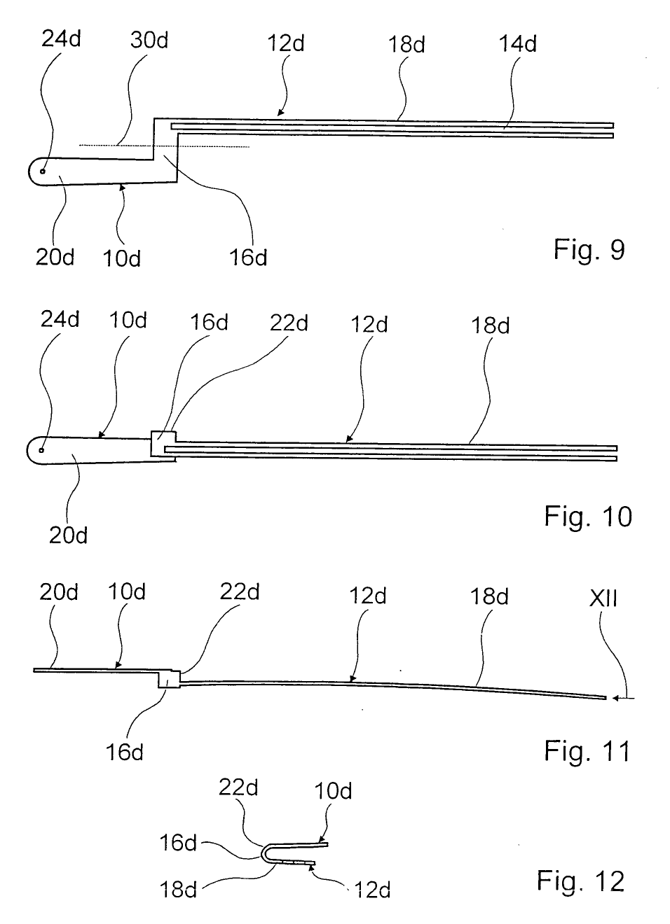

FIGS. 9 through 12 depict a wiper lever that is an alternative to that in FIGS. 6 through 8. The wiper lever features a connecting piece 16d formed by a transverse piece, which is aligned transverse to the longitudinal extension of the wiper lever, and via which a wiper arm 10d and a wiper blade 12d of the wiper lever are connected in a non-articulated manner. The wiper arm 10d, the connecting piece 16d and the wiper blade 12d are executed as a single piece and are formed of a common, long-stretched-out, punched bent component made of an elastic steel sheet.

Before a bending process that follows a punching process, the wiper lever is essentially executed to be flat (FIG. 9). In the bending process, the wiper blade 12d is bent in the direction of the wiper arm 10d, and namely by approx. 180° around a bending axis 30d, which runs parallel to the longitudinal extension of the wiper blade 12d, in the area of the connecting piece 16d so that the wiper arm 10d and the wiper blade 12d align.

Essentially a 180° deviation 22d is created in the area of the connecting piece 16d via which the wiper arm 10d and the wiper blade 12d are connected to each other (FIGS. 10, 11 and 12).

In addition to or as an alternative to the wiper blade 12d, the wiper arm 10d could also be bent around the bending axis 30d.

The wiper blade 12d is connected to the wiper arm 10d via its inner wiper blade end and via the connecting piece 16d.

A bearing force is transferred during operation to the wiper blade 12d in the area of an inner circle of the wiper blade 12d or from the wiper arm 10d via the connecting piece 16d and via the outer wiper blade end.

In order to fasten a wiper strip to the wiper blade 12d, a slot-shaped recess 14d is introduced into an elastic, curved wiper strip supporting element 18d of the wiper blade 12d and the recess is executed to be open in the area of the free end of the wiper blade 12d.

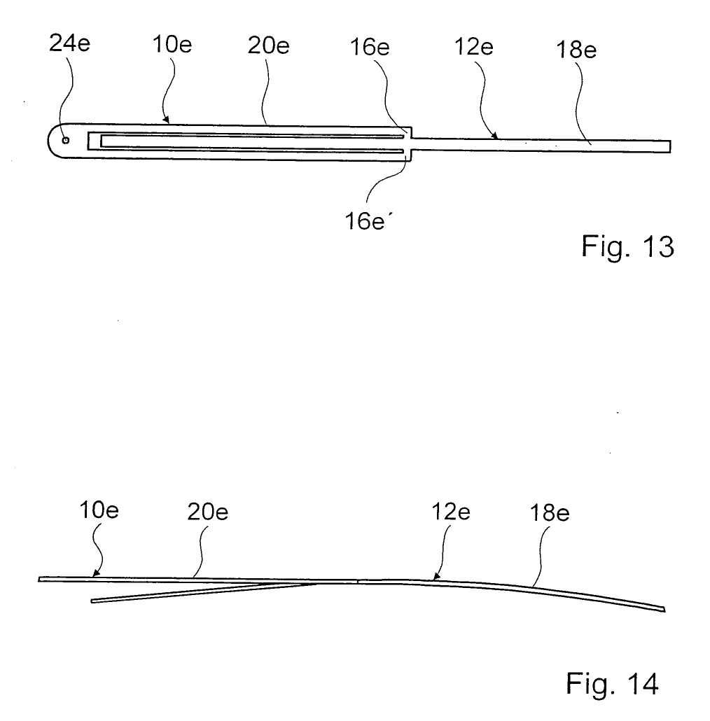

FIGS. 13 and 14 depict a wiper lever that is an alternative to that in FIGS. 1 through 3. The wiper lever features connecting pieces 16e, 16e′ formed by transverse pieces, which are aligned transverse to the longitudinal extension of the wiper lever, and via which a wiper arm 10e and a wiper blade 12e of the wiper lever are connected in a non-articulated manner. The wiper arm 10e, the connecting pieces 16e, 16e′ and the wiper blade 12e are executed as a single piece and are formed of a common, long-stretched-out, punched bent component made of an elastic steel sheet. When observed in the unbent state, the wiper arm 10e and the wiper blade 12e feature a common longitudinal axis, whereby a wiper blade part is formed of a free-punched part of a sheet metal section that also forms the wiper arm 10e.

The wiper blade 12e is connected to the wiper arm 10e via its longitudinal center section and via the connecting pieces 16e, 16e′. A bearing force is transferred during operation to the wiper blade 12e in the area of a center circle of the wiper blade 12e or from the wiper arm 10e via the connecting pieces 16e, 16e′ and via the longitudinal center section of the wiper blade 12e.

A wiper strip that is executed as a hollow profile can be slid onto the wiper blade's 12e wiper strip supporting element 18e that is executed as a whole surface or without a recess, or a wiper strip can be adhered to it. However, the wiper strip supporting element 18e could also be executed with a slot-shaped recess extending over its length and open towards one end or both ends, into which a wiper strip can be inserted.

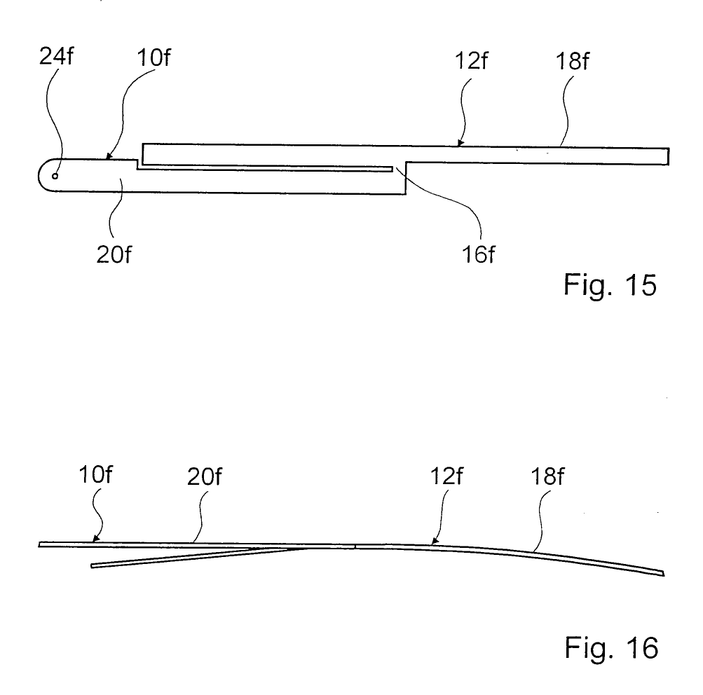

FIGS. 15 and 16 depict a wiper lever that is an alternative to that in FIGS. 13 through 14, which, instead of two connecting pieces 16e, 16e′, only features one connecting piece 16f formed by one transverse piece, via which a wiper arm 10f and a wiper blade 12f are connected in a non-articulated manner.

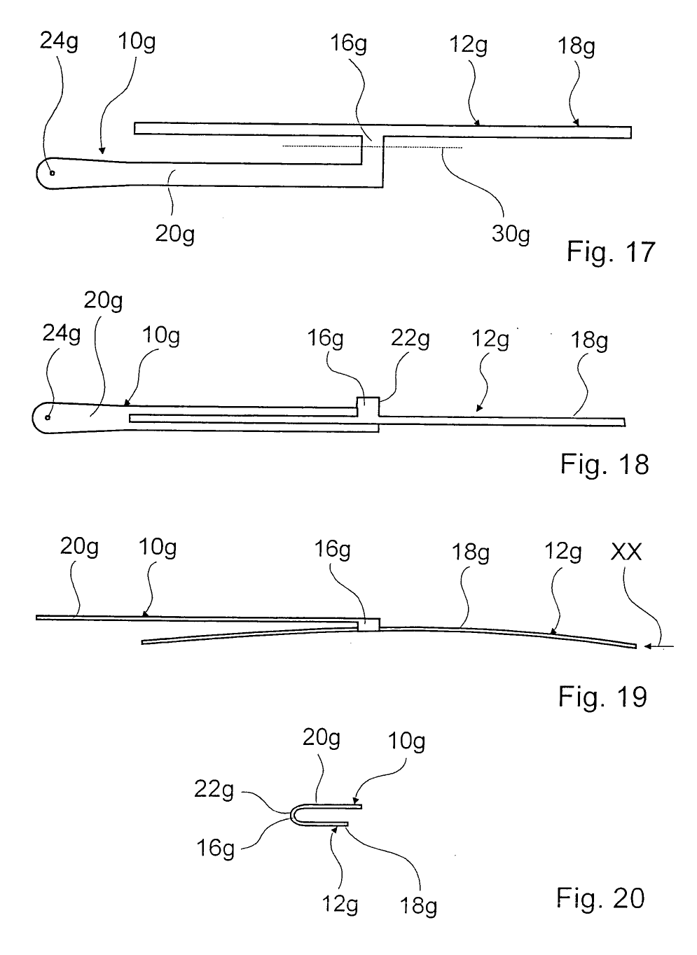

FIGS. 17 through 20 depict a wiper lever that is an alternative to that in FIGS. 15 through 16. The wiper lever features a connecting piece 16g formed by a transverse piece, which is aligned transverse to the longitudinal extension of the wiper lever, and via which a wiper arm 10g and a wiper blade 12g of the wiper lever are connected in a non-articulated manner. The wiper arm 10g, the connecting piece 16g and the wiper blade 12g are executed as a single piece and are formed of a common, long-stretched-out, punched bent component made of an elastic steel sheet.

Before a bending process that follows a punching process, the wiper lever is essentially executed to be flat (FIG. 17). In the bending process, the wiper blade 12g is bent in the direction of the wiper arm 10g, and namely by approx. 180° around a bending axis 30g, which runs parallel to the longitudinal extension of the wiper blade 12g, in the area of the connecting piece 16g so that the wiper blade 12g and the wiper arm 10g essentially align.

Essentially a 180° deviation 22g is created in the area of the connecting piece 16g via which the wiper arm 10g and the wiper blade 12g are connected to each other (FIGS. 18, 19 and 20). In addition to or as an alternative to the wiper blade 12g, the wiper arm 10g could also be bent around the bending axis 30g.

The wiper blade 12g is connected to the wiper arm 10g via its longitudinal center section and via the connecting piece 16g. A bearing force is transferred during operation to the wiper blade 12g in the area of a center circle of the wiper blade 12g or from the wiper arm 10g via the connecting piece 16g and via the longitudinal center section of the wiper blade 12g.

A wiper strip that is executed as a hollow profile can be slid onto the wiper blade's 12g wiper strip supporting element 18g that is executed as a whole surface or without a recess, or a wiper strip can be adhered to it. However, the wiper strip supporting element 18g could also be executed with a slot-shaped recess extending over its length and closed towards one end or both ends, into which a wiper strip can be inserted.

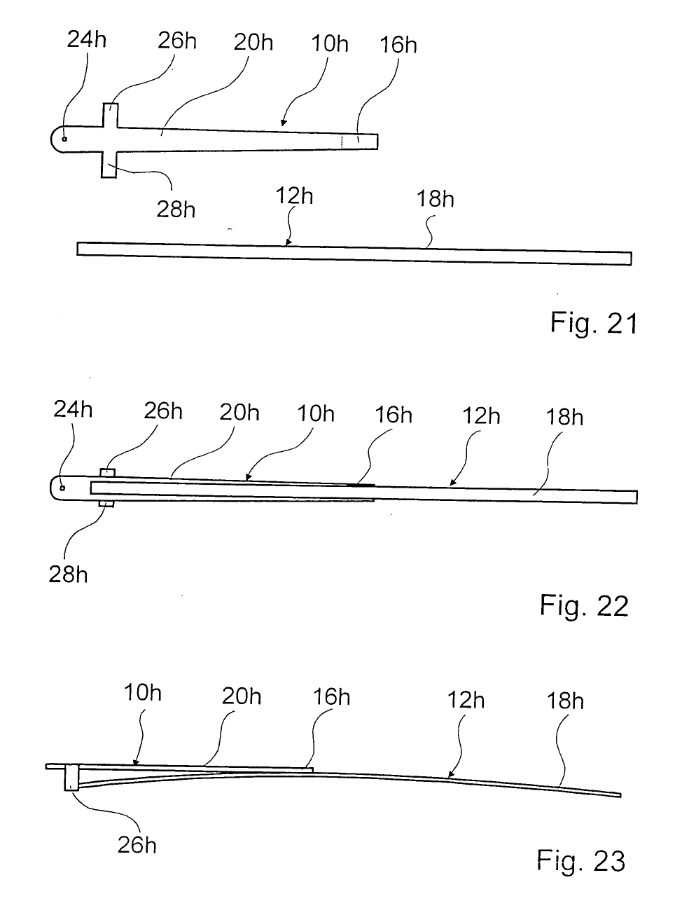

FIGS. 21 through 23 depict an alternative wiper lever with a wiper arm 10h and a wiper blade 12h in various manufacturing stages, wherein the wiper arm 10h and the wiper blade 12h, as finished in accordance with the invention, are connected in a non-articulated manner by an elastic connecting piece 16h (FIG. 23). The wiper arm 10h and the connecting piece 16h are executed as a single piece and are formed of a common, long-stretched-out, punched bent component made of an elastic steel sheet. The wiper arm 10h features a recess 24h on one end for coupling to a drive shaft, while the connecting piece 16g is arranged on a second end of the wiper arm 10h. The wiper blade 12h is formed of a punched bent component, embodied separate from the wiper arm 10h and the connecting piece 16h, and features a lower material strength than the wiper arm 10h and the connecting piece 16h.

The longitudinal center section of the wiper blade 12h is welded to the connecting piece 16h in a manufacturing step (FIGS. 22 and 23). In addition, in a bending process, brackets 26h, 28h that are formed on the wiper arm 10h are bent 90° in the direction of one underside of the wiper lever and the brackets form a wiper blade guidance on the inner circle of the wiper blade 12h.

The wiper blade 12h is connected to the wiper arm 10h via its longitudinal center section and via the connecting piece 16h. A bearing force is transferred during operation to the wiper blade 12h in the area of a center circle of the wiper blade 12h or from the wiper arm 10h via the connecting piece 16h and via the longitudinal center section of the wiper blade 12h.

A wiper strip that is executed as a hollow profile can be slid onto the wiper blade's 12h wiper strip supporting element 18h that is executed as a whole surface or without a recess, or a wiper strip can be adhered to it.

However, the wiper strip supporting element 18h could also be executed with a slot-shaped recess extending over its length and closed towards one end or both ends, into which a wiper strip can be inserted.

1. Wiper lever with a wiper arm (10a-10h) and a wiper blade (12a-12h), characterized in that the wiper arm (10a-10h) and the wiper blade (12a-12h), are connected to each other in a non-articulated manner.

2. Wiper lever according to claim 1, characterized in that the wiper arm (10a-10h) and a wiper blade (12a-12h) are connected via at least one elastic connecting piece (16a-16h).

3. Wiper lever according to claim 1, characterized in that the wiper blade (12a-12h) features an elastic wiper strip supporting element (18a-18h) connected to the wiper arm (10a-10h) in a non-articulated manner, on whose concave side a wiper lip of a wiper strip extends in an assembled state.

4. Wiper lever according to claim 1, characterized in that the wiper arm (10a-10h) features at least, one elastic-supporting element (20a-20h).

5. Wiper lever at least according to claim 2, characterized in that the connecting piece (16a-16h) is executed as a single piece with at least, one elastic supporting element (18a-18g, 20a-20h).

6. Wiper lever according to claim 1, characterized in that the wiper arm (10a-10g) and the wiper blade (12a-12g) are executed at least partially as a single piece.

7. Wiper lever according to claim 6, characterized in that the wiper arm (10a-10g) and the wiper blade (12a-12g) are formed of a common punched bent component.

8. Wiper lever according to claim 1, characterized in that the wiper blade (12a) is connected to the wiper arm (10a) via its outer wiper blade end.

9. Wiper lever according to claim 1, characterized in that the wiper blade (12b-12d) is connected to the wiper arm (10b-10d) via its inner wiper blade end.

10. Wiper lever according to one of the preceding lam claim 1, characterized in that the wiper blade (12e-12h) is connected to the wiper arm (10e-10h) via an area between its wiper blade ends.

11. Wiper lever according to claim 1, characterized in that the wiper arm (10c-10g) is connected to the wiper blade (12c-12g) via at least one transverse piece.

12. Wiper lever according to claim 1, characterized in that the wiper arm (10a, 10b, 10d, 10g) and the wiper blade (12a, 12b, 12d, 12g) are connected via at least one deviation (22a, 22b, 22d, 22g) with an angle greater than 90°.

13. Wiper lever according to claim 1, characterized in that the wiper blade (12a, 12b, 12d) features at least one slot-shaped recess (14a, 14b, 14d) to accommodate a wiper strip.

14. Wiper lever according to claim 2, characterized in that the wiper blade (12a-12h) features an elastic wiper strip supporting element (18a-18h) connected to the wiper arm (10a-10h) in a non-articulated manner, on whose concave side a wiper lip of a wiper strip extends in an assembled state.

15. Wiper lever according to claim 14, characterized in that the wiper arm (10a-10h) features at least, one elastic-supporting element (20a-20h).

16. Wiper lever at least according to claim 15, characterized in that the connecting piece (16a-16h) is executed as a single piece with at least, one elastic supporting element (18a-18g, 20a-20h).

17. Wiper lever according to claim 16, characterized in that the wiper arm (10a-10g) and the wiper blade (12a-12g) are executed at least partially as a single piece.

18. Wiper lever according to claim 17, characterized in that the wiper arm (10a-10g) and the wiper blade (12a-12g) are formed of a common punched bent component.

19. Wiper lever according to claim 18, characterized in that the wiper blade (12a) is connected to the wiper arm (10a) via its outer wiper blade end.

20. Wiper lever according to claim 19, characterized in that the wiper blade (12b-12d) is connected to the wiper arm (10b-10d) via its inner wiper blade end.

21. Wiper lever according to claim 20, characterized in that the wiper blade (12e-12h) is connected to the wiper arm (10e-10h) via an area between its wiper blade ends.

22. Wiper lever according to claim 21, characterized in that the wiper arm (10c-10g) is connected to the wiper blade (12c-12g) via at least one transverse piece.

23. Wiper lever according to claim 22, characterized in that the wiper arm (10a, 10b, 10d, 10g) and the wiper blade (12a, 12b, 12d, 12g) are connected via at least one deviation (22a, 22b, 22d, 22g) with an angle greater than 90°.

24. Wiper lever according to claim 23, characterized in that the wiper blade (12a, 12b, 12d) features at least one slot-shaped recess (14a, 14b, 14d) to accommodate a wiper strip.
